(19) United States
(12) Patent Application Publication
(10) Pub. No.: US 2014/0139576 A1
(43) Pub. Date: May 22, 2014

(54) ELECTROCHROMIC WO3 NANOPARTICLES, A METHOD FOR THEIR PRODUCTION AND INK USING SAID PARTICLES

(71) Applicants: Claudia Brito da Costa, Vila Do Conde (PT); Carlos Alberto Pinheiro Baptista, Freiburg (DE); Inês Domingues da Silva Henriques, Alges (PT); César António Tonicha Laia, Lisboa (PT)

(72) Inventors: Claudia Brito da Costa, Vila Do Conde (PT); Carlos Alberto Pinheiro Baptista, Freiburg (DE); Inês Domingues da Silva Henriques, Alges (PT); César António Tonicha Laia, Lisboa (PT)

(73) Assignees: UNIVERSIDADE NOVA DE LISBOA, Caparica (PT); YD YNVISIBLE, S.A., Carta (PT)

(21) Appl. No.: 14/232,501

(22) PCT Filed: Jul. 13, 2012
(86) PCT No.: PCT/PT2012/000029

§ 371 Date: Jan. 13, 2014

(30) Foreign Application Priority Data
Jul. 14, 2011 (PT) 105814

(51) Int. Cl. C09D 11/00

(52) U.S. Cl. CPC C09D 11/32
USPC 347/10; 106/31.13; 423/606

(57) ABSTRACT

Tungsten trioxide (WO3) nanoparticles are synthesized via a sol-gel route using metallic tungsten as precursor and printed on a flexible electrode using inkjet printing in order to build solid-state electrochromic cells. A method for separate control of different spectral regions of the electrochromic device (near infrared and visible) is disclosed.

### TECHNICAL FIELD

This disclosure is in the field of electrochemistry.

### SUMMARY OF THE INVENTION

WO3 nanoparticles sized 200 nm were synthesized via a sol-gel method. An inkjet formulation of these nanoparticles is proposed, which was deposited on the surface of flexible and heat sensitive PET/ITO electrode. The hydrated nanoparticles have simultaneously amorphous and crystalline (hexagonal) states. It is demonstrated that such WO3 coating have electrochromic activity with a good chromic contrast. Spectroelectrochemical measurements evidenced a dual response in the visible and the NIR part of the spectrum depending of the applied voltage. Such behavior is connected to the presence of amorphous and crystalline states on the nanoparticles, and might be used in the future to construct devices in which light can be filtered on the NIR or NIR/Visible regions by controlling the applied voltage. We therefore propose the exploration of this phenomenon in applications such as electrochromic windows, which would allow the entrance of visible sunlight while filtering the NIR part of the spectrum at low voltages. The application on flexible substrates can be useful too, in which NIR contrast might be used in the future for displaying hidden messages in augmented reality applications. Future synthetic efforts will surely be crucial for possible commercial applications of this technology, in order to obtain even better contrast at low voltage in the NIR region of the spectra.

### BRIEF DESCRIPTION OF THE FIGURES

FIG. 1 is a scheme of a solid-state electrochromic device architecture with polyethylene terephthalate (PET) substrate coated with ITO.

FIG. 2 displays DSC and TGA analysis of the WO3 synthesized nanoparticles, at a scan rate of 10° C./min.

FIG. 3 displays XRD spectra of synthesized powder, commercial WO3, sintered and lyophilized powder

FIG. 4 displays FTIR and Raman Spectra of synthesized powder, commercial WO3, sintered and lyophilized powder

FIG. 5 is a profilometry measurement of an inkjet printed WO3 film at the edge of the printed area.

FIG. 6 is a cyclic voltammogram of an inkjet printed WO3 film (synthesized WO3 nanoparticles).

FIG. 7 displays Visible-NIR spectra showing the change in absorbance when an electrical voltage is applied through a device (see FIG. 1).

FIG. 8 displays the change of absorbance plotted against applied voltage to the device.

FIG. 9—(left) is a close-up of an inkjet printed WO3 (synthetized) film cyclic voltammogram at a scan rate of 1 mV·s-1. It evidences the appearance of a small reduction peak around 0.3V and (right) decomposition spectra from the normalized change in absorbance to obtain the two theoretical spectra of the two different species.

FIG. 10 displays chronoabsorptometry measurements of electrochromic devices built with the WO3 inkjet printed films, at 0.9V, 1.5V and 2 v at the beginning of the experiment and 1000 cycles after

FIG. 11 comprises photos of a flexible electrochromic device build with the WO3 (synthetized nanoparticles) inkjet printed films on PET/ITO in on/off states.

### DETAILED DESCRIPTION OF THE INVENTION

### 1. Introduction

Printed electronics is a challenging technology development area, with potential applications in everyday life. Basically, it pertains the construction of electronic devices with or on unconventional materials, such as plastic foils or paper, on which transistors, light-emitting devices or electrochromic displays or indicators can be produced. These devices need to be flexible, so that they can be used as inexpensive electronics, with low cost and accessible production methods. In this context, inkjet printing plays an important role, and there is numerous prior art using it to build conductive layers, transistors and light-emitting devices.

Electrochromic cells can also be built using this deposition method. In electrochromism, the active materials can be organic molecules such as viologens and leuco dyes, semiconductor polymers such as PEDOT or metal oxides such as tungsten trioxide (WO3). WO3 is one of the most well-known electrochromic materials. Its application is well reviewed by several books and papers and, along with viologens, it has been employed commercially. Its popularity stems from the strong color contrast, covering a wide range of the solar spectrum, with a relatively low production cost. This metal oxide displays transitions in the near infrared region, thus being able to filter an important part of the solar spectrum.

The usual deposition method for this metal oxide is sputtering, and much of the literature applies this technique. To use other methods such as inkjet printing it is important to synthesize the compound as nanoparticles, which can be achieved using a sol-gel method, in a way that will not damage the printer nozzles. Normally, in this case, amorphous WO3 nanoparticles are obtained, which can be followed by a sinterization process in order to make crystalline nanoparticles or coatings. Such heat treatment, however, is not usable on heat sensitive substrates such as plastics or paper, and thereby the applicability of this electrochromic material on flexible printed electronics is greatly reduced. Bearing these problems in mind, this disclosure is of a method in which electrochromic WO3 nanoparticles are synthesized via the sol-gel route, and then deposited on a flexible electrode using inkjet printing without the sinterization step. A characterization of both nanoparticles and of the printed film obtained by inkjet printing is given using several different techniques. Spectroelectrochemical measurements show the electrochromic activity of the solid state cells obtained, where optical activity occurs not only on the visible portion of the spectra, but also in the near-infrared (NIR) region. Combining all different results, it is possible to assign two different crystalline states for WO3 that will yield different electrochromic responses, enabling the implementation of a method that allows the independent control of the NIR region (responsible for heat transference) from the visible region (responsible for the glare effect) of the electromagnetic spectra. The printed films samples have high redox cyclability.

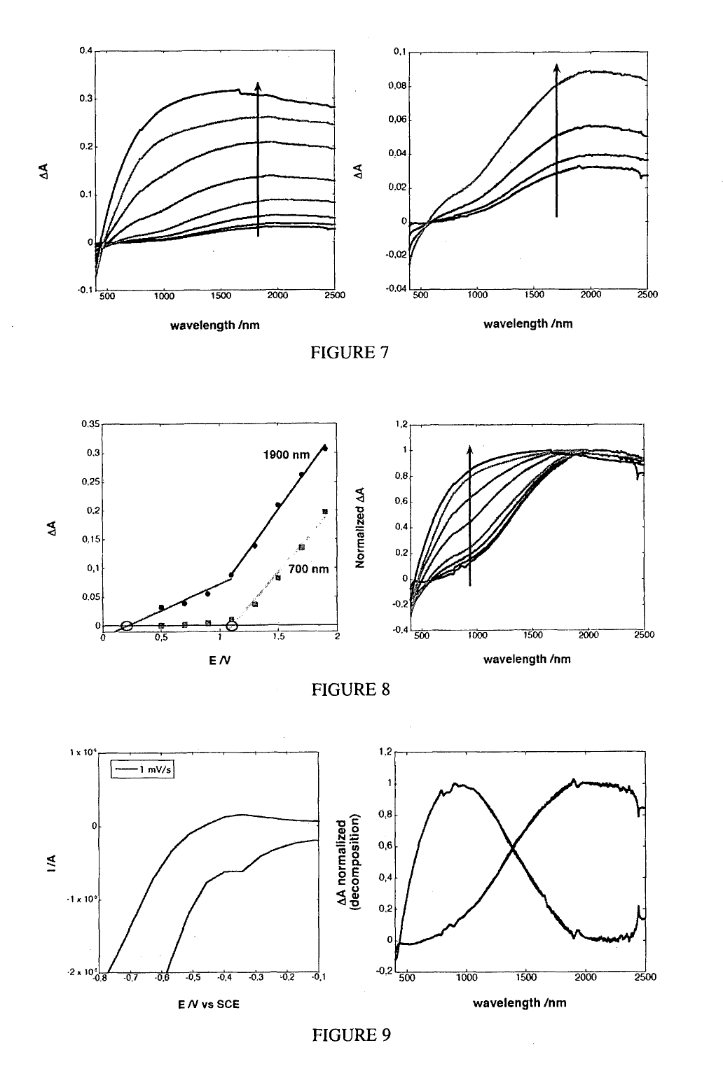

FIG. 7 displays Visible-NIR spectra showing the change in absorbance when a voltage is applied on the device, between the on (i.e. negative voltage, reduced WO3) and the off (i.e. positive voltage, oxidized WO3) states at 0.5, 0.7, 0.9, 1.1, 1.3, 1.5, 1.7, and 1.9V (left) and a zoom of the spectra obtained with lower voltages (right).

FIG. 8 displays a change of absorbance plotted against the applied voltage, at 700 and 1900 nm (left) and normalized change of absorbance for 0.5, 0.7, 0.9, 1.1, 1.3, 1.5, 1.7, and 1.9V (right).

### 2 Experimental Stage

### 2.1 Reagents

The following reagents were used: metallic tungsten (99.9%), hydrogen peroxide (30%), absolute ethanol (PA, 99.5%), tungsten (VI) oxide (99.9%), Triton X-100, diethylene glycol (99%), methanol and lithium perchlorate (98%). A polyethylene oxide-polypropylene oxide copolymer (PEO-PPO) was used as support for the electrolyte layer. Indium tin oxide (ITO) coated PET with a surface resistivity of 60 Ω/sq was also employed.

### 2.2 WO3 Nanoparticles Synthesis

Metallic tungsten was added to hydrogen peroxide and allowed to react for about three minutes until a clear transparent colourless solution was formed (without aging or heating). This solution was heated (100° C.) under stirring in a closed vessel, giving a yellow solution after approximately 2 hours. A pale yellow precipitate appears after approximately 5 hours under the same conditions. The resulting powder was obtained after solvent evaporation, which was characterized using experimental techniques described below, showing the presence of WO3 nanoparticles. The composition of the powder was studied using X-ray Fluorescence (XRF) and elemental analysis techniques. XRF measurements were performed in an ArtTAX spectrometer with a molybdenum (Mo) anode, an Xflash detector refrigerated by the Peltier effect (Sidrift), and a mobile arm. The experimental parameters used were: 40 kV of voltage, 300 μA of intensity, for 200 seconds. Two XRF spectra were made, one for the synthesized powder and another using commercial WO3 powder. The two spectra aligned perfectly, showing that there was no other element (heavier than oxygen) in the composition of the two powders. Elemental analysis was performed in an Elemental Analyzer. Again, a comparison with commercial WO3 powder was performed to determine differences in terms of percentage of carbon and hydrogen elements. The carbon percentage was practically the same (0.22% for the sol-gel powder and 0.24% for the commercial powder) in both samples.

In the sol-gel powder, however, hydrogen was also detected (0.64%), an element that is undetectable on the commercial powder.

### 2.3 Lyophilization and Sinterization

To obtain the lyophilized powder, an aqueous dispersion of the powder described in 2.2 was used. The sintered powder was obtained using the powder described in 2.2 and heating it at 500° C. for approximately two hours on a muffle furnace.

### 2.4 Inkjet Ink Formulation

This powder can be dispersed in water, giving a relatively stable colloidal suspension (characterized by sedimentation techniques, see below), and additives, such as alcohols, dispersants and surfactants with different compositions were introduced in order to optimize the dispersion stability. The goal was to obtain dispersions that could be used as inkjet inks, therefore viscosity, pH and surface tension had to be adjusted.

### 2.5 Ink Printing

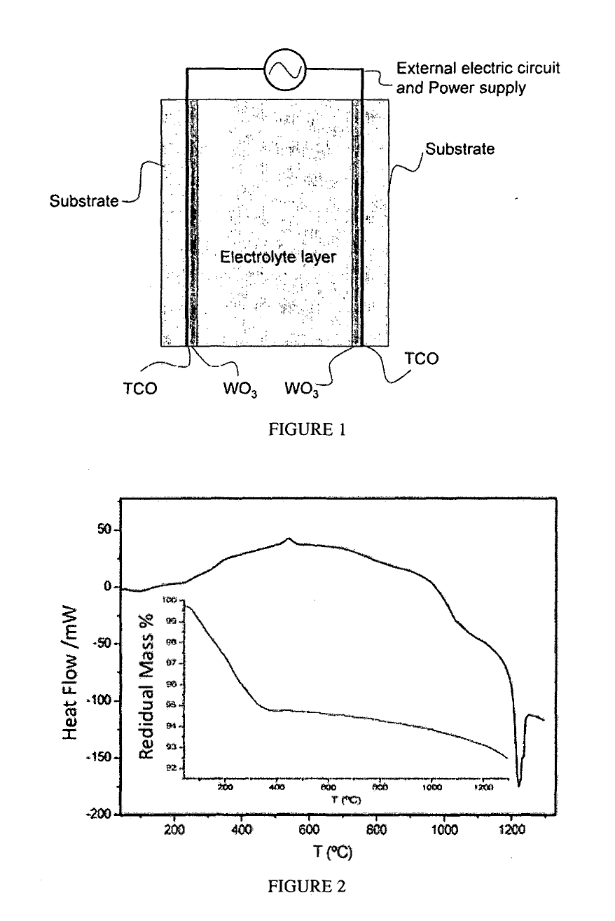

Two drop-on-demand piezo (DOD piezo) inkjet printers (an Epson® Stylus Photo 8285) desktop inkjet printer and a lab-scale Dimatix® materials printer (DMP-2800)) were used to print the WO3 layer of the electrochromic devices. The WO3 ink was printed on top of the transparent conductive oxide (TCO) of the PET/ITO substrate (FIG. 1). The ink was printed using a waveform with an applied voltage of 14V and a firing drop frequency of 6 kHz. The drops were small and without tails. A 20 μm drop spacing was employed.

### 2.6 Device Assembly

The architecture of the devices is shown in FIG. 1. WO3 is deposited by inkjet printing on top of the ITO layer. The lithium-based polymer electrolyte was spread-coated on top of one of the WO3 layers and allowed to dry for approximately 1 hour. The device was closed and sealed.

### 2.7 Particle Characterization Techniques

### 2.7.1 Dynamic Light Scattering (DLS)

DLS experiments were performed in order to measure the particles size distribution on dispersions in water/ethanol (1:1) of WO3 synthesized nanoparticles. A Brookhaven Instruments BI-90 was employed with the following specifications:

Speed: 1 minute;

### Accuracy: +1%;

Sample volume: 0.5-3 ml.

The mean particle size value and the standard deviation were calculated (size distribution by weight) assuming a Logonormal fit. The diffusion coefficient was measured for different sample concentrations and an extrapolation for infinite dilution was made. The particle size was determined using the Stokes-Einstein equation.

### 2.7.2 Dispersion Analysis

Ink sedimentation velocity and nanoparticles size were determined on different dispersions of sol-gel synthesized WO3 nanoparticles with a Lumisizer dispersion analyzer. This apparatus allows acquisition of space- and time-resolved extinction profiles over the sample length. Parallel light (I0) illuminates the entire sample cell and transmitted light (I) is detected by sensors arranged linearly across the sample from top to bottom. Transmission is converted into extinction and particle concentration is calculated, therefore allowing the sedimentation velocity to be determined. Centrifugal force is used to accelerate the sedimentation process. The equipment uses an indirect method to determine the nanoparticles size using the density of the solid and the liquid phases, the liquid viscosity and the sedimentation velocity, by applying Stokes Law.

### 2.7.3 Profilometry Measurement

The profilometry measurements were made in a KLA-Tencor Alpha Step D 100 Mechanical Profiler with a stylus force of 0.03 mg to avoid scratching the material.

### 2.7.4 X-Ray Diffraction (XRD), Fourier Transform Infrared Spectroscopy (FTIR) and Raman Spectroscopy

XRD measurements were made on a powder X-Ray diffractometer for powders, 30 kV/15 mA, with copper X-Ray tubes. Infrared analyses were performed on a spectrophotometer. Spectra were obtained in absorbance mode, with a resolution of 8 cm and 64 scans. Spectra are shown here as acquired, without corrections or any further manipulation, except for baseline correction. The samples consisted of WO3 powder grounded with potassium bromide. This powder mixture was then compressed in a mechanical press to form a translucent pellet through which the spectrophotometer infrared light beam. Raman spectroscopy was made in a Labram 300 JobinYvon spectrometer equipped with a He/Ne laser 17 mW operating at 632.8 nm using the WO3 powder.

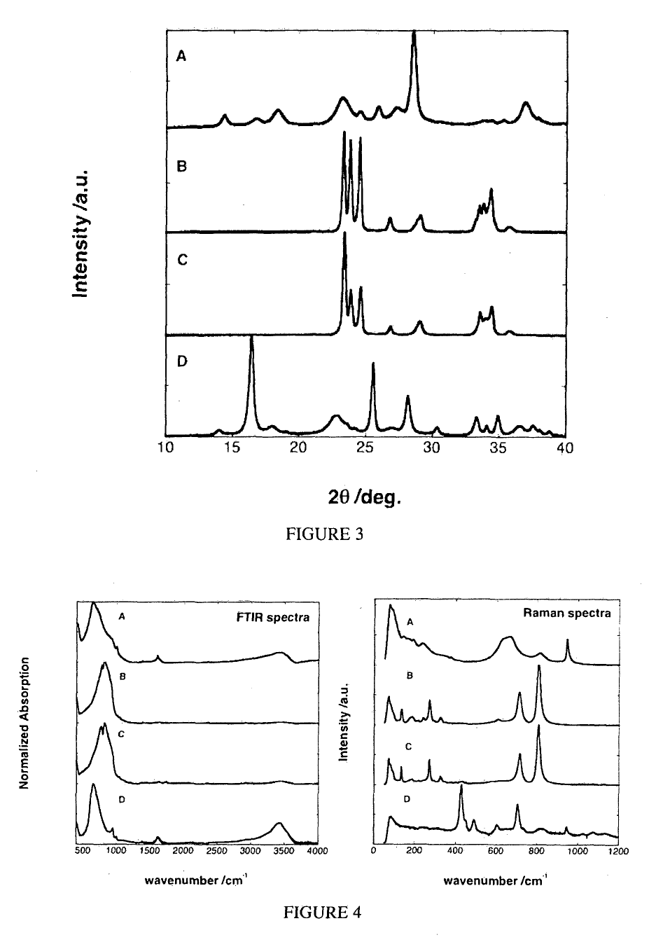

FIG. 3 displays XRD spectra of synthesized powder A, commercial WO3 B, synthesized powder sintered at 550° C. for 1 hour C, and synthesized powder dispersed in water, followed by 1 week ageing and finally lyophilized in order to obtain D.

FIG. 4 displays FTIR and Raman Spectra of synthesized powder (A), commercial WO3 (B), synthesized powder sintered at 550° C. for 1 hour (C) and synthesized powder dispersed in water, followed by 1 week ageing and finally lyophilized in order to obtain (D).

### 2.7.5 Differential Scanning Calorimetry (DSC) and Thermogravimetric Analysis (TGA)

DSC and TGA analysis were performed on the WO3 nanoparticles powder with a Netzsch STA 409 PC Luxx. The scan temperature was between 40° C. and 1300° C. and the scan rate used was 10° C./min.

### 2.8 Surface Tension and Viscosity Measurements

Ink surface tension was measured with a KSV Instruments Sigma 70 (Monroe, Conn.). The Du Noüy ring method was used (R=9.545 mm, r=0.185 mm and l=119.9 mm) and the surface tension obtained value was corrected following the Zuidema-Watersmethod. The standard glass beaker had a 66 mm diameter and 110 ml maximum volume. The sample volume used was 80-100 ml. Five measurements were conducted for each sample. Ink viscosity measurements were made with a Brookfield LVT viscometer. 20 ml samples were used to measure three viscosity values at three different velocities: 30, 12 and 6 rpm. A special cylinder (1 to 100 cps) for low viscosities was used. Density was measured with a 25 ml pycnometer.

### 2.9 Electrochemical Measurements

Electrochemical measurements on WO3 inkjet printed films were performed in a conventional three-electrode cell. The WO3 film deposited on an ITO electrode was the working electrode, a platinum wire was used as counter-electrode, a saturated calomel electrode (SCE) was the reference electrode and the supporting electrolyte was a polymer with lithium salt. For the solid-state electrochromic device a two-electrode cell configuration was used. The working electrode and the counter-electrode were both a layer of WO3 film printed on the TCO, with the polymer electrolyte sandwiched between them, as described above (see FIG. 1). The equipment used was a potentiostat/galvanostat. The collection of data was controlled by GPES version 4.9 Eco Chemie BV software. No IR compensation was used.

### 2.10 Spectroelectrochemical Measurements

In-situ UV/Vis absorbance spectra and chronoabsorptometry measurements of the WO3 films were performed using a UV-Vis-NIR spectrophotometer Varian Cary 5000 (spectral range from 220 to 3000 nm). The device was potentiostatic or potentiodinamically controlled with a potenciostat/galvanostat Model 20 Autolab as described in 2.8. The two-electrode cell configuration is the same of 2.8. The device was placed in the spectrophotometer compartment perpendicularly to the light beam. The potenciostat/galvanostat applied a square-wave form electric potential (at selected values described below), and the spectrophotometer registered the absorbance at the wavelengths selected for each experiment within the range of the equipment. Stability cycling tests were also performed in the same device.

### 3. Results and Discussion

3.1—Sedimentation measurements and Dynamic Light Scattering (DLS) measurements of the sol-gel WO3 particles dispersions were performed. DLS was done in water/ethanol mixtures 1:1 (v/v) and allowed the determination of diffusion coefficients D, which can be afterwards used to calculate the particle size. Samples with different volume fractions of dispersed phase (φ) were measured, allowing determination of D at each sample. It is known that extrapolations to infinite dilution are necessary to avoid interference of the attractive or repulsive forces between particles. This interference can be modeled by: D=D0(1+α [symbol] )(1), where D0 is the diffusion coefficient at infinite dilution and α is the virial coefficient. The virial coefficient provides information on the type of interactions that occur between nanoparticles. For hard spheres or when the interactions are repulsive due to electrostatic forces, α is positive, while when attractive interactions take place the virial coefficient is negative. The samples were previously filtered at 1 μm and 200 nm. Table 1 summarizes the values obtained from these experiments.

TABLE 1

| | D0/cm2 · s−1 | α | d/nm |
|---|---|---|---|
| Filtration: 1 μm | (9.7 ± 0.1)10e−9 | 0 ± 0.1 | 230 ± 10 |
| Filtration: 200 nm | (1.6 ± 0.1)10e−8 | 0 ± 0.1 | 160 ± 10 |

The data shows that a is close to zero, meaning that repulsive and attractive interaction forces in this system are well balanced, cancelling each other. Stokes-Einstein equation was then applied to calculate the average particle diameter d: d=(kBT/3πηD0)(2), where kB is the Boltzmann constant, T is the absolute temperature (298 K) and η is the solvent viscosity. The average particle diameters were in the range 160-225 nm, depending on the filtration used. As expected, the diameters decrease slightly after filtration through a 200 nm filter. Sedimentation velocity was determined by analytical centrifugation (see experimental section). This type of measurement relies on Stokes law (for particle diffusion under an acceleration field) and Lambert-Beer law (in order to convert optical transmission to particle concentration). Sedimentation velocity u depends on particle diameter, according to the following equation for diluted samples: u= 1/18·Δρde2/η·we2r (3), where op is the density difference between particles and the solvent, ω is the angular velocity and r is the radial position. ωe2r represents the centrifugal acceleration experienced by the particles at each radial position. The profiles of optical transmission vs. radial position vs. time are obtained at different rotational speeds, and using Lambert-Beer law, one can determine the sedimentation velocity for each angular velocity. In this work, a normalized optical transmission value was chosen in order to avoid meniscus and bottom cell artifacts. Radial positions vs. time were taken in order to calculate the sedimentation velocity for a given angular velocity, which afterwards enables the particle diameter calculation. A plot of u vs. ωe2r/g (where g is the gravity acceleration constant) should give a straight line in which the slope is u for earth gravity. This experimental value can then be compared with those calculated using the particle diameter obtained in DLS experiments, taking into account the solvent viscosity of each sample. The sedimentation velocity is a measure of the stability of the inks. Therefore, an optimization of the ink formulation was done, by measuring u. From this optimization, we arrived to the conclusion that the ink made from WO3 suspension in water, which was allowed to rest 1 week, had a sedimentation velocity equal to 7 mm/day (filtration 1 μm). In the case of the solutions similar to those used for DLS measurements, the value obtained was 5.7 mm/day, which compares very well with value predicted using the particle size obtained by DLS (7.3 mm/day). These values are also good enough for the use of these formulations as inkjet inks. Inkjet formulations, due to the nozzle sizes of these printers (a nozzle size is typically around 20 μm for a 10 μl drop), require particles with a size smaller than 1 μm. This requirement excluded formulations with salt since the particles aggregate rather easily in such conditions. Such effect is due to the fact that WO3 nanoparticles are negatively charged: when salt is added the electrostatic repulsion is cancelled and the force balance is shifted towards attractive interactions. An interesting effect is the aging of the particles. Indeed after 1 day the sedimentation velocity decreases to about half of the initial value, becoming stable afterwards. Therefore aging improves the colloidal stability of the system, probably due to a better hydration of the WO3 interface.

### 3.2 Thermal and Calorimetric Measurements

FIG. 2 shows a Differential Scanning calorimetry (DSC) and a Thermogravimetry analysis (TGA) of the synthesized sol-gel WO3 nanoparticles without sinterization or lyophilisation treatments. In DSC a small exothermic crystallization peak is observed at 550° C. Some other endothermic processes, around 100° C. and from 250° C. to 350° C., seem also to take place, but their intensity is rather small. TGA analysis shows material loss in this region, thus these processes are mainly linked to solvent evaporation. An intense endothermic peak above 1200° C. is detected, without any significant mass change in TGA data, indicating a phase transition at this region (probably, it is the melting point, although for pure WO3 it is reported to be 1473° C. —such discrepancy could be due to the composition of the nanoparticles).

### 3.3—Particle Characterization by X-Ray Diffraction (XRD), FTIR and Raman Spectroscopy

XRD, FTIR and Raman spectroscopy are here employed with the aim of characterizing the crystallinity of the synthesized powder. The DSC measurement clearly shows presence of solvent molecules (mainly water) and an endothermic crystallization peak at 550° C. It is also known that sol-gel synthesized particles normally lead to the formation of amorphous material which may be submitted to heat treatment after deposition to make crystalline particles (see references in introduction). The strategy consisted in analyzing four different WO3 powders in order to make a comparison. Besides the synthesized powder (A) and the commercial WO3 (B), two more powders were obtained: one in which A was sintered at 550° C. for 1 hour (C) and another powder by dispersing A in water, followed by 1 week ageing and finally lyophilisation in order to obtain the “dry” powder D. Therefore with powder C we are able to characterize the crystallization process at 550° C., while with powder D the main objective was to check if dispersion and ageing had an effect on the crystallinity of powder A. One must be aware, however, that the lyophilisation treatment also can lead to change of crystallinity, which will be further discussed below.

The XRD spectra (FIG. 3) show well-defined diffraction peaks for all samples. However each sample displays different crystallinity. A (the synthesized particles) shows peaks consistent with a hexagonal structure (JCPDS card 35-1001, hexagonal phase of WO3.0.33H2O) that indeed has some water molecules incorporated. As expected from the specifications of the supplier, B shows a cubic structure (JCPDS card 46-1096, cubic phase of WO3) without presence of water molecules. C has a tetragonal structure (JCPDS card 53-0434, tetragonal phase of WO3), different from B, but also without water molecules. This result confirms that at 550° C., the solvent is removed and the particles change their crystallinity. Powder D displays an orthorhombic structure (JCPDS card 43-0679, orthorhombic phase of WO3.H2O). Therefore not only D has a different crystalline structure compared with A, but also it is more hydrated as seen from the fraction of water that XRD spectra analysis shows. Finally XRD peaks of A and D suggest that probably an amorphous phase co-exists (more broad and with less intensity peaks are obtained).

FTIR and Raman spectra can provide a better answer for the presence of amorphous phase and/or hydration of WO3. Several revealing features are observed in this set of spectra (see FIG. 4). At 3400 cm-1 and 1615 cm-1 intense absorption IR peaks are observed on powders A and D. These results were obviously expected, since they correspond to vibrational modes of water molecules. These peaks are almost absent on powders B and C. Powder A and D also display a transition at 946 cm-1 with small intensity in FTIR spectra, but more evident in the Raman spectra, which is attributed to W═O or terminal W—O in amorphous compounds. Around 820 cm-1 every sample displays a transition which relative intensity depends on the powder. These transitions are attributed to the W—O stretching mode, which is shifted to lower wavenumbers when the material is in amorphous state rather than in crystalline state. This stretching mode also appears on samples B and C around 710 cm-1 (more clear in the Raman spectra). Abroad peak appears at 636 cm⁻¹ for powder A, inexistent in the other measurements, which is related with O—W—O bending mode for a hydrated sample. This bending mode appears at 328 cm-1 and 274 cm-1 for samples B and C, but in this case without the presence of water molecules. For powder D, the result seems in between the other samples and difficult to interpret. All peaks below 200 cm-1 observed in powders B and C are attributed to lattice modes WO3 crystalline particles. The lattice modes are absent in A and D.

### 3.4—Inkjet Printing Characterization

As explained in the experimental section, 20 μm drop spacing was employed in the deposition of WO3 in a PET/ITO substrate, using a Dimatix® printer. If no droplet agglomeration were observed, a continuous WO3 film would be seen in those images. However, WO3 islands are observed, with a size of approximately 200 μm. The formation of those islands is related with two different factors: agglomeration of deposed droplets due to capillarity effects (the contact angle between the ink and PET/ITO is) 40°, but also from the drying of the droplets, which is not instantaneous.

WO3 particles are clearly seen, with sizes ranging from 100 to 200 nm in accordance with DLS and sedimentation experiments. The rugosity of PET/ITO without WO3 particles is much smaller than this (around 5 nm) showing clearly this rugosity comes only from the WO3 coating. This is an important aspect for electrochromism, since a higher rugosity implies a larger interfacial area with the electrolyte layer, thus facilitating the Li+ insertion in the electrochromic material.

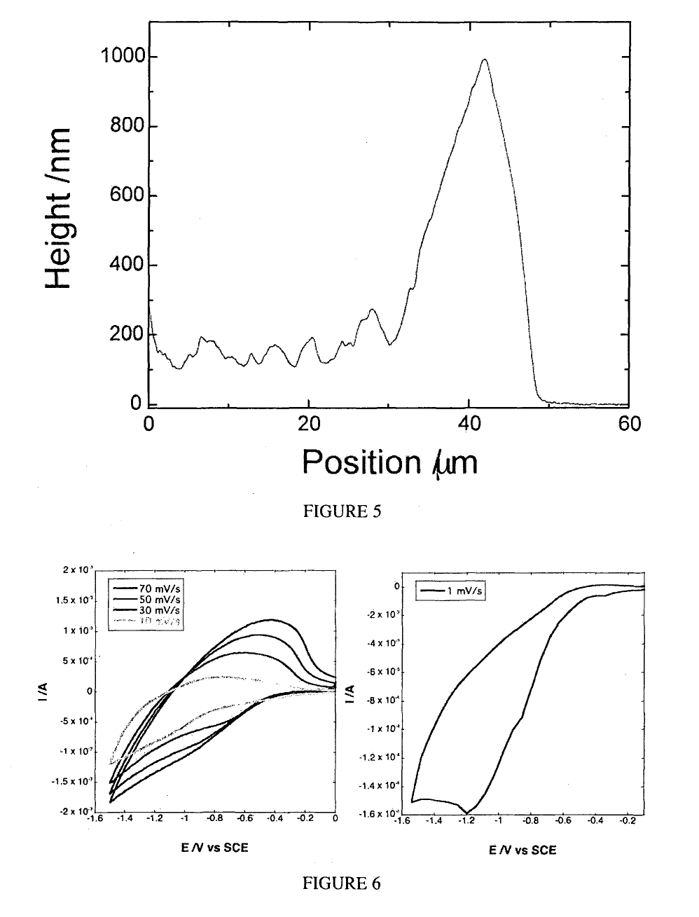

FIG. 5 shows a profilometry measurement of a WO3 film inkjet printed. At the border of the film, a large height (1 μm) is observed, but after about 20 μm the height quickly drops to about 200 nm. This result shows, therefore, a high particle concentration at the border of WO3 “film island”, but afterwards the height is in conformity with a monolayer of WO3 particles which have 200 nm of diameter. That large height at the border probably indicates how the solvent evaporates, from the inside to the outside, leading to that “hill” registered in the profile measurement.

Attempts were made to print powders B and C. However, 1 μm filtration is mandatory, in order to avoid damaging of the nozzles. Dispersions with these crystalline powders resulted into particles with sizes too large to pass the filter and therefore could not be deposited by inkjet. Such limitation was not observed with D, which could be deposited by inkjet.

### 3.5—Electrochemical Characterization

The PET/ITO substrates coated with WO3 nanoparticles by inkjet printing were electrochemically characterized. On FIG. 6, a cyclic voltammetry study of such coatings is shown. The results are in accordance with others previously published for WO3. The oxidation wave shows a peak at −0.4 V, but the reduction wave does not show the corresponding reduction peak. This behavior was discussed previously, and several explanations were put forward, from which two are described here (other explanations are found in the review by Monk):

A—Faughnan and Crandall model (potentiostatic coloration—this model relies in two main assumptions: the rate limiting motion is the cation entering the WO3 layer from the electrolyte layer, because of a back electromotive force (emf) is created at the interface. W(V) is considered to be the only species existing in the film initially, meaning that cations are absent in the electrochromic layer. The back emf is particularly important in this model, because it explains the absence of a reduction peak.
B—Ingram, Duffy and Monk model (electronic percolation threshold)—this model assumes that there is a percolation threshold where below it, the electron motion is the rate limiting step, instead of the cation in model A. Above this threshold, the model A and B are similar. Now models A and B invoke a “characteristic time”, which is proportional to the squared film thickness divided by the cation diffusion coefficient. Due to back emf, the response time will exceed this characteristic time. For usual scan rates (50 mV·s-1), this implies the absence of the reduction peak, but at smaller scan rates it can appear. In order to check out this aspect, slower scan rates were investigated. Indeed, for 1 mV·s-1 a reduction peak was found at −1,25V, at expense of the oxidation peak (FIG. 5). Slow scan rate enables Li+ diffusion to take place, promoting the reduction of the electrochromic film, however the oxidation (accompanied by the cations exit from the electrochromic layer) is too fast in comparison to the reduction, so the very well defined oxidation peak is lost. FIG. 5 also shows the decreasing intensity of the oxidation peak with the decreasing scan rate, accompanying by a shift of that peak. Besides the reduction peak at −1.25V, a small peak seems to appear at −0.8V as well. The origin of this peak is not completely clear from these results, but considering the nature of the nanoparticles (presence of amorphous and crystalline phases, and existence of interfacial WO3 which may have different redox properties from those in the core of the particles) it is possible that two different “states” are present. This aspect is clear in the spectroelectrochemical measurements shown below.

### 3.6—Vis-NIR Spectroelectrochemistry

The optical properties of the WO3 films were characterized by VIS-NIR spectroelectrochemistry in the wavelength range 400 to 2500 nm and voltage range −2 to 2V. The measurements were made on a solid-state electrochromic cell, and therefore contain all the components of the device, including the TCO and the electrolyte layers. FIG. 7 shows the change in absorbance when a voltage is applied on the device, between the on (i.e. negative voltage, reduced WO3) and the off (i.e. positive voltage, oxidized WO3) states. Even for low voltages such as −0.5 V, a change of absorbance between on and off states is observed. This response is only active in the NIR portion of the spectra for voltages below −1.1 V. At voltages below this threshold, the absorption spectra peaks around 1900 nm, deep in the NIR region, and an isosbestic point is observed. An isosbestic point is indicative of a conversion between two species. Above this threshold, the peak position shifts to around 1400 nm as the voltage increases, and the visible portion of the spectra becomes active. The isosbestic point disappears, which indicates the presence of a third species.

This shift is best viewed when the change of absorbance is normalized at the peak (FIG. 8). Indeed, for low voltage the optical activity is observed for wavelengths above 1200 nm, while the second component appears with the concomitant shift of the absorption spectra at high voltages. If ΔA is plotted against the applied voltage, at 700 nm the signal only appears above −1.1 V, but at 1900 nm two regimes appear, one above −1.1 V and a second one above −0.3 V (value obtained by extrapolation). The cyclic voltammogram with low scan rate indeed shows a wave at −1.2 V, but it also shows a very small peak around −0.3 V (see FIG. 9). These results point out for two different species with different redox potentials and a different absorption spectroscopy.

−1.1 V is the electric potential point at which optical activity starts to be in the visible light range, whilst there is optical activity in the near-infrared range even below −1.1 V. FIG. 7 is a cyclic voltammogram for the WO3 synthesized nanoparticles measured at several scan rates (left) and cyclic voltammogram with 1 mV·s-1 scan rate measurement showing the appearance of the reduction peak (right).

Different behaviors of the optical absorption for amorphous and polycrystalline WO3 films were described above. In the case of amorphous WO3, it was found that the absorption peak is much more shifted into the blue, a result explained because the localization radius of the electron states is much smaller than in a crystalline phase. Small-polaron absorption theory explains this result qualitatively, as described earlier. Alternatively, a theory based on intervalence charge transfer absorption was given even earlier, in which the absorption spectra is caused by charge transfer mechanisms between W(V) and W(VI). In both cases, while amorphous films are optically active at higher energies (hence, visible range of the spectrum), polycrystalline states are active in NIR region. This interpretation is in accordance with the data obtained by Raman and XRD spectroscopy (see above), where both amorphous and crystalline (hexagonal) states are observed. So for low voltage, the hexagonal portion of the WO3 nanoparticles is being reduced, while higher voltages are required for the amorphous portion of the nanoparticles.

### 3.7—Response Time and Cycling

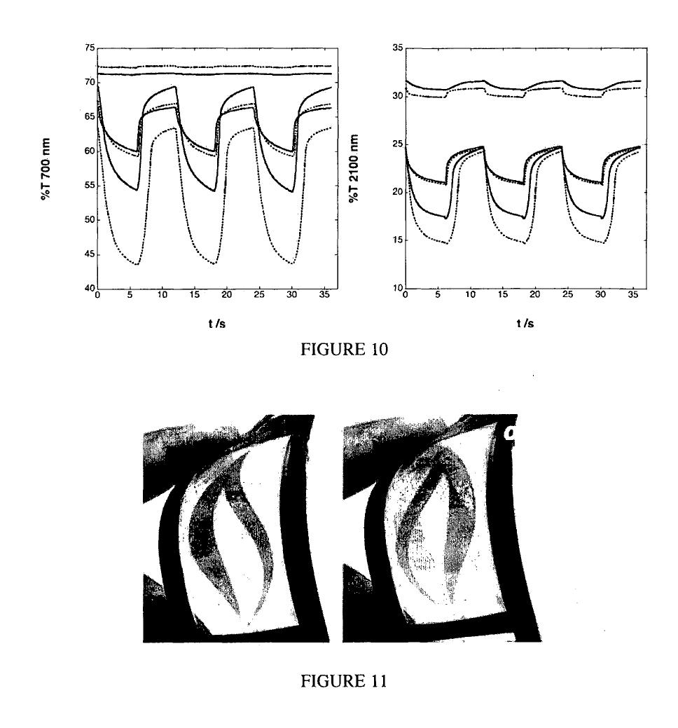

The device stability was tested by doing on/off cycles, by alternating between a given voltage and monitoring at 700 and 2100 nm (see FIG. 10). The transmittance contrast for −0.9/+0.9 V cycles is rather small, but for −1.5/+1.5 V cycles the colour stability is measurable and very good after 1000 cycles in both spectral regions, with a slight increase of transmittance contrast. The contrast, however, improves strongly when −2.0/+2.0 V cycles are applied after 1000 cycles although the transmittance decreases by about 5% at 700 nm (probable due to some electrolyte layer degradation, which causes a yellowing of the device when many cycles are performed). The performance enhancement is much more evident for this case, which probably indicates a better cation insertion at the electrochromic layer.

FIG. 9 shows cycling measurements of electrochromic devices measured at 700 nm (left) and at 2100 nm (right), built with the WO3 printed films and tested at 0.9V (blue), 1.5V (green) and 2V (red), the straight lines shows the initial cycles and the dot lines shows the devices performance after 1000 cycles.

FIG. 11 shows photos of the device in on/off states, where the color contrast obtained is best viewed. The device is bendable, without any significant loss of optical activity, and almost completely transparent in the off state, 25% loss of absorbance contrast was obtained only after 50000-2.01+2.0 V cycles with 6 s of duration.

Table 2 shows more details about the electrochromic performance of the device. The colouration time τc and bleaching time Tb were measured, as well as the electric current and the so-called colouration efficiency CE. CE is rather high at 2100 nm, especially with −0.9/+0.9 V cycles. The colouration/bleaching times, however, are better in the visible region, probably because the amorphous component of the nanoparticles are more accessible for cation insertion. The total electric current Qc and Qb are similar for a given voltage, confirming the stability of the assembled devices.

| Voltage/V | wavelength/nm | Qc/mC · cm-2 | Qb/mC · cm-2 | Δ% T | ΔA | CE/cm2 · C-1 | τc/s | τb/s |
|---|---|---|---|---|---|---|---|---|
| 0.9 | 700 | −0.30 | 0.27 | 0.7 | 0.008 | 29 | — | — |
| 1.5 | 700 | −0.90 | 0.91 | 12.5 | 0.034 | 38 | 1.7 | 2.5 |
| 2.0 | 700 | −3.0 | 3.1 | 26.0 | 0.090 | 27 | 2.0 | 1.7 |
| 0.9 | 2100 | −0.30 | 0.27 | 3.9 | 0.040 | 133 | >6 | >6 |
| 1.5 | 2100 | −1.00 | 1.00 | 12.5 | 0.092 | 88 | >6 | >6 |
| 2.0 | 2100 | −2.9 | 3.1 | 16.6 | 0.161 | 55 | 2.5 | 2.4 |

TABLE 2 contains electric current, transition time for colored and bleached states, coloration efficiency, change in absorbance and in transmittance for 0.9, 1.5 and 2V at 700 and 2100 nm of a flexible electrochromic device build with the WO3 printed films on PET/ITO.

### BIBLIOGRAPHIC REFERENCES

1 “Polymer electroluminescent devices processed by inkjet printing: I. Polymer light-emitting logo”, J. Bharathan and Y. Yang, Appl. Phys. Lett., 1998, 72, 2660.
2 “Printable all-organic electrochromic active-matrix displays”, P. Andersson, R. Forchheimer, P. Tehrani and M. Berggren, Adv. Funct. Mater., 2007, 17, 3074.
3 “Plastic-compatible low resistance printable gold nanoparticle conductors for flexible electronics”, D. Huang, F. Liao, S. Molesa, D. Redinger and V. Subramanian, J. Electrochem. Soc., 2003, 150, G412.
4 “Inkjet printing of nanosized silver colloids”, H. H. Lee, K. S. Chou and K. C. Huang, Nanotechnology, 2005, 16, 2436.
5 “Excimer laser processing of inkjet-printed and sputter-deposited transparent conducting SnO2: Sb for flexible electronics”, W. M. Cranton, S. L. Wilson, R. Ranson, D. C. Koutsogeorgis, K. Chi, R. Hedgley, J. Scott, S. Lipiec, A. Spiller and S. Speakman, Thin Solid Films, 2007, 515, 8534.
6 “Inkjet printing of narrow conductive tracks on untreated polymeric substrates”, T. H. J. Van Osch, J. Perelaer, A. W. M. de Laat and U.S. Schubert, Adv. Mater., 2008, 20, 343.
7 “Electrochromism and Electrochromic Devices”, P. M. S. Monk, R. J. Mortimer and D. R. Rosseinsky, Cambridge University Press: United Kingdom, 2007.
8 C. G Granqvist, “Handbook Of Inorganic Electrochromic Materials”, Elsevier: The Netherlands, 2002.
9 “Electrochromic tungsten oxide films: Review of progress 1993-1998”, C. G. Granqvist, Sol. Energ. Mat. Sol. C., 2000, 60, 201.
10 “Advances in chromogenic materials and devices”, C. G. Granqvist, S. Green, G. A. Niklasson, N. R. Mlyuka, S. von Kraemer and P. Georen, Thin Solid Films, 2010, 518, 3046.
11 “Electrochromic windows: an overview”, R. D. Rauh, Electrochim. Acta, 1999, 44, 3165.
12 “Properties, requirements and possibilities of smart windows for dynamic daylight and solar energy control in buildings: A State-Of-The-Art Review”, R. Baetens, B. P. Jelle and A. Gustaysen, Sol. Energ. Mat. Sol. C., 2010, 94, 87.
13 “Electrochromism and Local Order In Amorphous WO3”, H. R. Zeller, H. U. Beyeler, Appl. Phys., 1977, 13, 231.
14 “Charge Movement Through Electrochromic Thin-Film Tungsten Trioxide”, P. M. S. Monk, Critical Revs. in Solid State & Mat. Sc., 1999, 24, 193.
15 “Amorphous And Crystalline Peroxopolytungstic Acids Formed From Tungsten And Hydrogen-Peroxide”, H. Okamoto, A. Ishikawa and T. Kudo, B. Chem. Soc. Jpn, 1989, 62, 2723.

1. Method for producing electrochromic particles, wherein there are the sequential steps of
mixing 5-10% metallic tungsten with 95-90% of hydrogen peroxide
allowing the mix to react until a colorless solution is achieved
stirring the colorless solution in a closed vessel at 100° C. until a yellow precipitate powder is formed.

2. The method of claim 1, wherein the mix is allowed to react for 3 minutes.

3. The method of claim 1, wherein the colorless solution is stirred for 5 hours.

4. The method of claim 1, wherein the aqueous solution is heated for 2 hours.

5. Electrochromic particles produced by the method of claim 1, wherein an ink which coloring agent is the electrochromic particles exhibits the following behavior
when subject to an electric potential up to −1.1 V (+/−0.5 V) it displays color alteration in the near-infrared and not in the visible range of light
when subject to an electrical potential of 1.1 V (+/−0.5 V) and higher it displays color alteration both in the near-infrared and the visible ranges of light.

6. Method for producing an ink, wherein there are the sequential steps of:
mixing 5-10% metallic tungsten with 95-90% of hydrogen peroxide
allowing the mix to react until a colorless solution is achieved
stirring the colorless solution in a closed vessel at 100° C. until a yellow precipitate powder is formed
dispersing the sintered powder in water until a stable colloidal suspension is achieved.

7. The method of claim 6, wherein the mix is allowed to react for 3 minutes.

8. The method of claim 6, wherein the colorless solution is stirred for 5 hours.

9. The method of claim 6, wherein the aqueous solution is heated for 2 hours.

10. Ink produced by the method of claim 6, wherein the following behavior is observed
when subject to an electric potential up to −1.1 V (+/−0.5 V) it displays color alteration in the near-infrared and not in the visible range of light
when subject to an electrical potential of −1.1 V (+/−0.5 V) and higher it displays color alteration both in the near-infrared and the visible ranges of light.

11. Method for inkjet printing the ink produced by the process in claim 6, wherein a waveform is used with the following parameters:
applied voltage of 14 V
firing drop sequence of 6 KHz
drop spacing of 20 μm.

12. An electrochromic ink, wherein
metallic tungsten particles are components of the ink
the following behavior is observed
when subject to an electric potential up to −1.1 V (+/−0.5 V) it displays color alteration in the near-infrared and not in the visible range of light
when subject to an electrical potential of −1.1 V (+/−0.5 V) and higher it displays color alteration both in the near-infrared and the visible ranges of light.
